(19) United States
(12) Patent Application Publication
(10) Pub. No.: US 2002/0129183 A1
(43) Pub. Date: Sep. 12, 2002

(54) Method of enhancing flow control in a data bus system by eliminating an acknowledge packet during a response phase to indicate a flow control condition

(76) Inventors: David Vernon James, Palo Alto, CA (US); Scott Smyers, San Jose, CA (US); Glen David Stone, Los Gatos, CA (US)

Correspondence Address: WAGNER, MURABITO & HAO LLP, Third Floor, Two North Market Street, San Jose, CA, 95113, US

(21) Appl. No.: 09/802,773

(22) Filed: Mar. 8, 2001

(51) Int. Cl. G06F 13/22

(52) U.S. Cl. 710/220

(57) ABSTRACT

A method of performing a data bus transaction in a data bus system is described, whereas the data bus transaction includes a request phase and a response phase. In an embodiment, the data bus system includes a plurality of nodes including a requester node and a responder node, whereas the data bus system is compliant with the 1394 Standard. The method of the present invention enhances flow control in the data bus system in particular circumstances so that to improve the data transfer rate of the data bus system. In particular, the method of the present invention accelerates the initiation of an arbitration process (so that to perform a next data bus transaction) relative to the end of the response packet transmitted during the response phase of a current data bus transaction. Moreover, the method of the present invention does not interfere with the protocols of the arbitration process of the data bus system.

### BACKGROUND OF THE INVENTION

1. Field of the Invention

The present invention generally relates to the field of data bus systems. More particularly, the present invention relates to the field of flow control incorporating a reduction in the transmission of Acknowledge packets during a response phase of a data bus transaction.

2. Related Art

The 1394 Serial Bus Standard (or 1394 Standard) is a protocol for a high performance digital serial data bus. The 1394 Standard provides a versatile, high-speed method of interconnecting a variety of devices (e.g., computer system, digital camera, digital VCR, TV settop box, digital camcorder, storage device, digital audio device, etc.). Moreover, the 1394 Standard enables a wide range of applications, including desktop video editing, publishing, data storage, video conferencing, and home Audio/Video networking. Rapid embrace of the 1394 Standard has been spurred by the emergence of digital video and multimedia applications.

The 1394 Standard offers many advantages over other technologies. The major advantages include very high speed data transfer rates, self-configuring, plug-and-play operation, both asynchronous data transfer (guaranteed delivery) and isochronous data transfer (guaranteed bandwidth with low overhead), and flexible topology.

The 1394 Standard was originally adopted in 1995 as the 1394-1995 specification. Later, the original specification was revised, providing some clarification on the original specification, changing some optional portions of the original specification to mandatory, and adding some performance enhancements. The first revision was approved and is known as the 1394a specification. A second revision of the 1394 Standard is known as the 1394b specification. The 1394b specification represents a significant enhancement of the 1394 Standard.

FIG. 1 illustrates the well-known protocol layers of the 1394 Standard, whereas each device compliant with the 1394 Standard implements the protocol layers. The 1394 Standard includes a transaction layer 20, a link layer 30, a physical layer 40, and a serial bus management layer 60. The protocol layers interact and interface with the host 10 (e.g., processor, PCI Bus, application, etc.) and with the 1394 connector, whereas the 1394 connector physically couples one device to another device. Each protocol layer is implemented as circuitry, software, or a combination of both.

The Link layer 30 provides acknowledged data transfer-services (in the asynchronous data transfer mode of a 1394 data bus system) between a source node and a destination node, whereas a node in a 1394 data bus system is a device (e.g., computer system, digital camera, digital VCR, TV settop box, digital camcorder, storage device, digital audio device, etc.) which is compliant with the 1394 Standard. The Link layer 30 defines a request-response protocol to perform a variety of data bus transactions. Examples of data bus transactions include a read and a write. The request-response protocol is a split transaction since the request-response protocol includes a request phase and a response phase. In addition, the transaction layer 20 provides a variety of services to facilitate the request-response protocol.

The physical layer 40 translates the data transfer requirements from the Link layer 30 into electrical signals to drive a conventional 1394 data bus system and receives signals from the conventional 1394 data bus system. In addition, the physical layer 40 provides an arbitration service to permit a node to gain access to the conventional 1394 data bus system and to guarantee that only one node at a time is transferring data. Also, the physical layer 40 is responsible for the electrical and mechanical interface in the conventional 1394 data bus system. Moreover, the physical layer 40 is responsible for the clocking scheme of the 1394 Standard. The physical layer 40 maintains a local clock, whereas each device has a respective local clock. Data transmissions from a transmitting device to a receiving device are synchronized by the local clock of the transmitting device. The transmitting device transmits data and its local clock to the receiving device. The receiving device recovers the local clock of the transmitting device and utilizes the recovered local clock to recover the data transmitted by the transmitting device.

FIG. 2 illustrates a timing diagram showing a typical example of the request-response protocol of the 1394 Standard according to the prior art. In particular, the timing diagram illustrates a DATA FLOW in a conventional 1394 data bus system, whereas the DATA FLOW includes the data transfers performed by a source node and a destination node via the conventional 1394 data bus system.

During the request phase 230, the source node (“requester node”) typically arbitrates for control of the conventional 1394 data bus system. Upon gaining control and access to the conventional 1394 data bus system, the requester node initiates a data bus transaction by transmitting a request packet 205 to the destination node (“responder node”). Here, the request packet 205 is transmitted between t=T1 and t=T2. Generally, the request packet 205 includes a command to be performed by the responder node. Moreover, the request packet 205 may include data. In response to the request packet 205, the responder node typically transmits an acknowledge packet 210 (ACK_{request}) to the requester node, whereas the acknowledging node (or responder node) does not have to arbitrate for the conventional 1394 data bus system since control of the conventional 1394 data bus system is automatic after receiving a request packet 205. The ACK_{request} 210 typically includes a code indicating a specific condition that occurred to the request packet 205 (e.g., the request packet 205 was accepted, the request packet 205 was not accepted, an error was detected, etc.). Here, the ACK_{request} 210 is transmitted between t=T3 and t=T4.

During the response phase 240, the destination node (“responder node”) typically arbitrates for control of the conventional 1394 data bus system. If the responder node responds quickly enough, the responder node may not need to arbitrate for control of the conventional 1394 data bus system. Upon gaining control and access to the conventional 1394 data bus system, the responder node proceeds towards completing the data bus transaction by transmitting a response packet 215 to the source node (“requester node”). Here, the response packet 215 is transmitted between t=T5 and t=T6. Generally, the response packet 215 includes a result requested by the requester node. In response to the response packet 215, the requester node typically transmits an acknowledge packet 220 (ACKᵣₑₛₚₒₙₛₑ) to the responder node, whereas the acknowledging node (or requester node) does not have to arbitrate for the conventional 1394 data bus system since control of the conventional 1394 data bus system is automatic after receiving a response packet 215. The ACKᵣₑₛₚₒₙₛₑ 210 typically includes a code indicating a specific condition that occurred to the response packet 215 (e.g., the response packet 215 was accepted, the response packet 215 was not accepted, an error was detected, etc.). Here, the ACKᵣₑₛₚₒₙₛₑ 220 is transmitted between t=T7 and t=T8.

Typically, the request and response phases of a first data bus transaction, performed by a first pair of nodes, are separated by the request and response phases of one or more second data bus transactions performed by one or more second pairs of nodes. Unfortunately, the request or response phases of the first data bus transaction cannot be performed while the request or response phases of the second data bus transaction are being performed. Thus, the data transfer rate of the conventional 1394 data bus system is limited by flow control factors related to the request-response protocol. In particular, the length of a first time period 230 associated with the request phase and the length of a second time period 240 associated with the response phase constrain the data transfer rate of the conventional 1394 data bus system. Moreover, the nodes in the conventional 1394 data bus system are unable to initiate the arbitration process to perform another data bus transaction until the request or response phase that is currently being performed has ended.

### SUMMARY OF THE INVENTION

A method of performing a data bus transaction in a data bus system is described, whereas the data bus transaction includes a request phase and a response phase. In an embodiment, the data bus system includes a plurality of nodes including a requester node and a responder node, whereas the data bus system is compliant with the 1394 Standard. The method of the present invention enhances flow control in the data bus system in particular circumstances so that to improve the data transfer rate of the data bus system. In particular, the method of the present invention accelerates the initiation of an arbitration process (so that to perform a next data bus transaction) relative to the end of the response packet transmitted during the response phase of a current data bus transaction. Moreover, the method of the present invention does not interfere with the protocols of the arbitration process of the data bus system.

These and other advantages of the present invention will no doubt become apparent to those of ordinary skill in the art after having read the following detailed description of the preferred embodiments which are illustrated in the drawing figures.

In an embodiment of the present invention, the response phase is modified such that under a particular flow control condition an acknowledge packet is transmitted from the requester node to the responder node in response to the response packet that is transmitted from the responder node to the requester node. In particular, during the response phase, the requester node transmits an acknowledge packet only to indicate the flow control condition that the requester node is busy and is unable to accept the response packet. Thus, the responder node interprets the condition of not receiving an acknowledge packet as a flow control condition which requires the responder node to terminate the current data bus transaction so that other data bus transactions can be performed by other nodes on the data bus system. Since the length of time required to transmit the acknowledge packet (from its start to its end) is longer than the length of time needed to detect that the start of the acknowledge packet has not been received within a responding time period, the response phase of the data bus transaction of the present invention can terminate earlier than the response phase of the data bus transaction of the prior art. Thus, the arbitration process can be initiated sooner in the data bus system of the present invention than in the conventional data bus system of the prior art, leading to a higher data transfer rate in the data bus system of the present invention.

In one embodiment, the present invention includes a method of performing a data bus transaction between a first node and a second node in a data bus system having a plurality of nodes, the method comprising the steps of: a) initiating the data bus transaction including a request packet generated by the first node and a response packet generated by the second node; b) transmitting the request packet to the second node; c) transmitting a first acknowledge packet to the first node; d) transmitting the response packet to the first node; e) initiating a start of a responsive time period; f) if the first node is unable to accept the response packet, initiating transmission of a second acknowledge packet to the second node prior to an end of the responsive time period; and g) if the second acknowledge packet of the step f) is not received, terminating the data bus transaction upon the end of the responsive time period, wherein the responsive time period is shorter than a time period between initiation of the start of the responsive time period and a terminal end of the second acknowledge packet.

In another embodiment, the present invention includes a method of performing a response phase of a data bus transaction between a first node and a second node in a data bus system having a plurality of nodes, the method comprising the steps of: a) transmitting a response packet to the first node; b) initiating a start of a responsive time period; c) if the first node is unable to accept the response packet, initiating transmission of an acknowledge packet to the second node prior to an end of the responsive time period, and d) if the acknowledge packet of the step c) is not received, terminating the data bus transaction upon the end of the responsive time period, wherein the responsive time period is shorter than a time period between the initiation of the start of the responsive time period and a terminal end of the acknowledge packet.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1 illustrates the well-known protocol layers of the 1394 Standard, whereas each device compliant with the 1394 Standard implements the protocol layers.

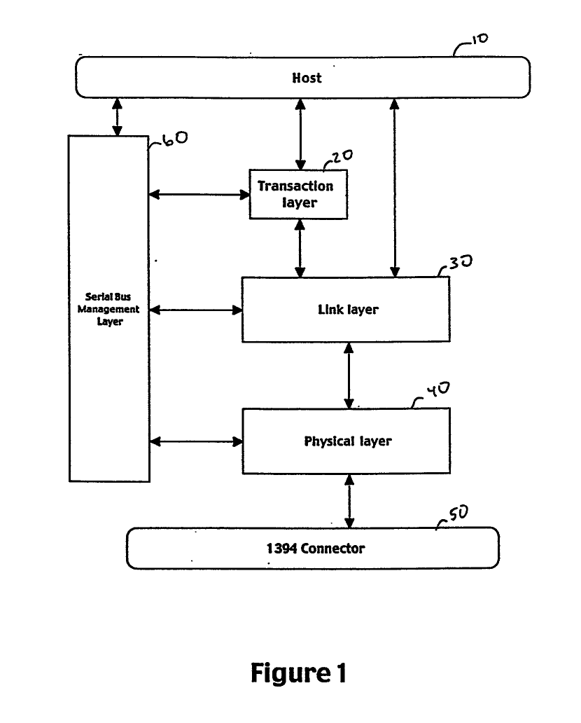

FIG. 2 illustrates a timing diagram showing a typical example of the request-response protocol of the 1394 Standard according to the prior art.

FIG. 3 illustrates a data bus system in which the present invention can be practiced.

FIG. 4 illustrates a timing diagram showing a response phase of a data bus transaction according to an embodiment of the present invention.

FIG. 5 illustrates a timing diagram showing a response phase of a data bus transaction according to a second embodiment of the present invention.

FIG. 6 illustrates a flow chart showing a method of performing a data bus transaction in accordance with an embodiment of the present invention.

The drawings referred to in this description should not be understood as being drawn to scale except if specifically noted.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Although the discussion will focus on a 1394 data bus system having a plurality of nodes (each node compliant with the 1394 Standard), the present invention is also applicable to data bus systems compliant with other standards implementing a request-response protocol with acknowledgment. Each node is a device (e.g., computer system, digital camera, digital VCR, TV settop box, digital camcorder, storage device, digital audio device, etc.) which is compliant with the 1394 Standard. Each node implements the 1394 Standard protocol layers. Each 1394 protocol layer is implemented as circuitry, software, or a combination of both

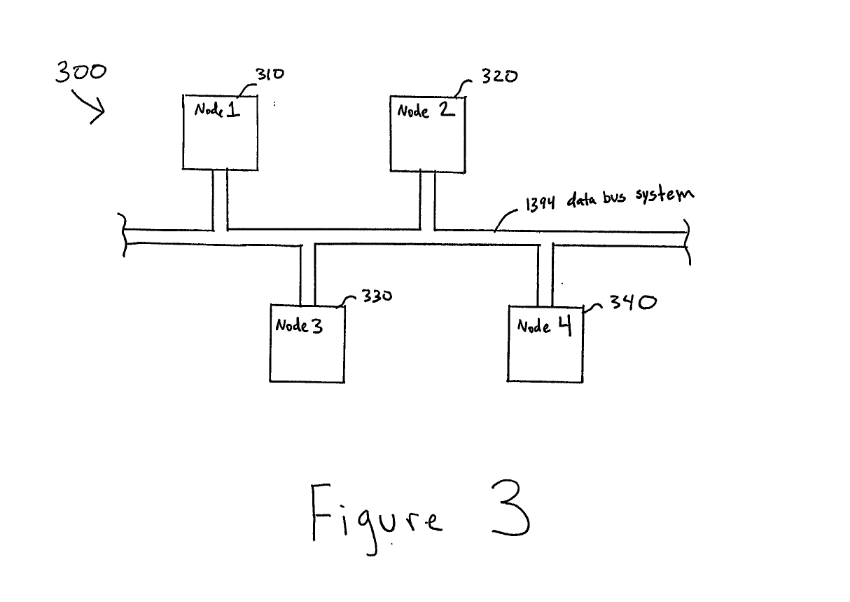

FIG. 3 illustrates a data bus system 300 in which the present invention can be practiced. In an embodiment, the data bus system 300 is a 1394 data bus system 300. The 1394 data bus system 300 has a plurality of nodes including a first node 310, a second node 320, a third node 330, and a fourth node 340. It should be understood that the 1394 data bus system 300 can be implemented in any number of configurations. The plurality of nodes (each node 310-340 compliant with the 1394 Standard) are coupled together to form the 1394 data bus system according an embodiment of the present invention. As discussed above, the 1394 Standard is comprised of a transaction layer, a link layer, a physical layer, and a serial bus management layer, whereas each 1394 protocol layer is implemented as circuitry, software, or a combination of both.

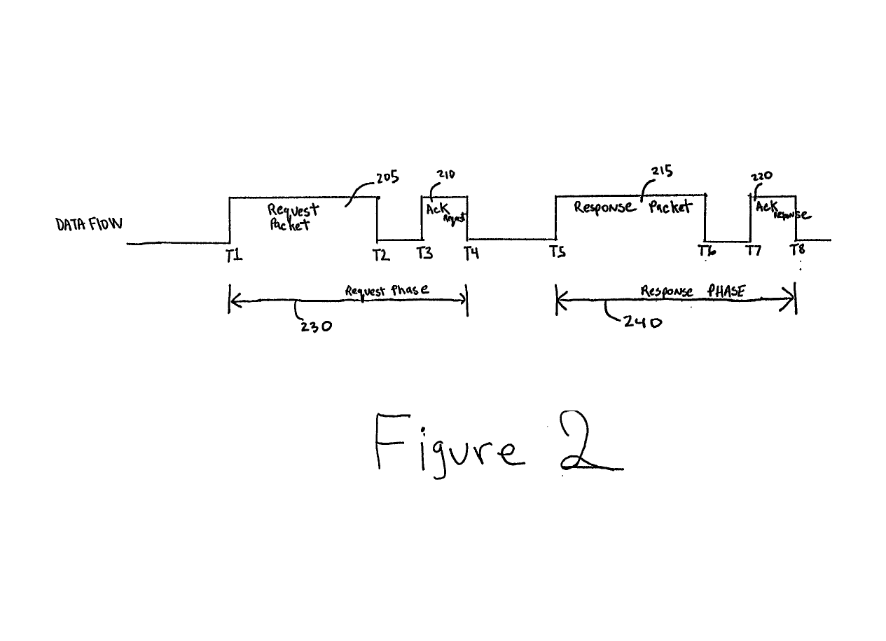

In an embodiment of the present invention, the plurality of nodes 310-340 utilize a new request-response process to perform a variety of data bus transactions (e.g., a write, a read, etc.), whereas the data bus transaction includes a request phase and a response phase. In particular, the new request-response process enhances flow control in the 1394 data bus system 300 in particular circumstances so that to improve the data transfer rate of the 1394 data bus system. The request phase of the new request-response process is performed as described above with respect to FIG. 2.

The advantages of the response phase of the new request-response process are based on a number of observations about the operation of the request-response process of the prior art. These observations relate to flow control. For instance, each node 310-340 has a limited input buffer for receiving a request packet or a response packet. In the request-response process of the prior art, if a particular node is unable to accept a packet (e.g., request packet or response packet) from a transmitting node (e.g., because the input buffer is full), the particular node transmits an acknowledge packet to the transmitting node to indicate (using predetermined code) that the particular node is busy and is unable to accept the packet (e.g., request packet or response packet). In response, the transmitting node typically attempts to re-transmit the packet (e.g., request packet or response packet) later. Typically, the transmitting node re-transmits the packet (e.g., request packet or response packet) only after the transmitting node has received the acknowledge packet indicating that the particular node is busy and is unable to accept the packet (e.g., request packet or response packet). Generally, in the request-response process of the prior art, the transmitting node does not re-transmit the packet (e.g., request packet or response packet) if the transmitting node has not received any acknowledge packet (e.g., because an acknowledge packet was not sent or because an acknowledge packet was transmitted but not received due to an error) or if the transmitting node has received an acknowledge packet indicating that the particular node has accepted the packet (e.g., request packet or response packet).

In particular, during the response phase of the request-response protocol of the prior art, the responder node does not re-transmit the response packet if the responder node has not received any acknowledge packet (e.g., because an acknowledge packet was not sent or because an acknowledge packet was transmitted but not received due to an error) from the requester node. Otherwise, if the responder node does re-transmit the response packet, it is possible that the requester node may interpret the re-transmitted response packet of a first data bus transaction as belonging to a unrelated second data bus transaction, causing an error. Typically, the requester node can perform an error recovery procedure if the requester node fails to receive the response packet from the responder node. In addition, in the request-response protocol of the prior art, if the responder node receives an acknowledge packet indicating that the requester node has accepted the response packet, the responder node typically proceeds to another data bus transaction and an arbitration is initiated among the nodes so that to perform another data bus transaction, as explained above. In other words, the responder node does not need the acknowledge packet (which indicates that the requester node has accepted the response packet) for a purpose other than to communicate information to the responder node.

The present invention provides a manner of quickly communicating information to the responder node concerning whether the requester node has accepted the response packet. In the response phase of the new request-response protocol of the present invention, flow control is enhanced by eliminating the transmission of an acknowledge packet to indicate a flow control condition other than that the requester node is busy and is unable to accept the response packet, in response to the response packet transmitted from the responder node to the requester node. Hence, the responder node interprets a failure to receive an acknowledge packet within a responding time-period as a flow control condition indicating that the responder node should terminate the present data bus transaction to allow a next data bus transaction to be performed on the 1394 data bus system 300. The length of the responding time period is shorter than the length of the time period between the end of the transmitted response packet and the end of the acknowledge packet indicating that the requester node is busy and is unable to accept the response packet (or the acknowledge packet indicating that the requester node has accepted the response packet), permitting the arbitration process for performing the next data bus transaction to be initiated sooner and leading to a higher data transfer rate in the 1394 data bus system 300 in accordance with the present invention. Moreover, if the requester node transmits an acknowledge packet to indicate that the requester node is busy and is unable to accept the response packet, the response phase of the new request-response protocol of the present invention resembles the response phase of the request-response protocol described above with respect to FIG. 2.

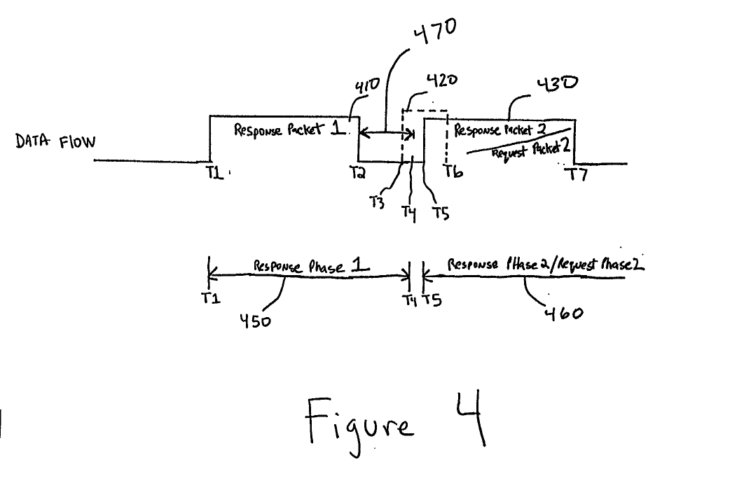

FIG. 4 illustrates a timing diagram showing a DATA FLOW which depicts a response phase of a data bus transaction utilizing the new request-response protocol according to an embodiment of the present invention, whereas the DATA FLOW includes the data transfers performed by a responder node and a requester node. As mentioned above, the request phase of the new request-response process is performed as described above with respect to FIG. 2. In the response phase of the new request-response protocol of the present invention, the responder node 310 (e.g., the first node 310 in FIG. 3) arbitrates for control of the 1394 data bus system 300 (FIG. 3). If the responder node 31 0 responds quickly enough, the responder node 31 0 may not need to arbitrate for control of the 1394 data bus system 300. Upon gaining control and access to the 1394 data bus system 300, the responder node 310 proceeds towards completing the data bus transaction by transmitting a response packet 410 to the requester node 320 (e.g., the second node 320 in FIG. 3). Here, the response packet 410 is transmitted between t=T1 and t=T2. In addition, the responder node 310 initiates the start of a responding time period 470 at t=T2, whereas the responding time period 470 ends at t=T4.

In a first case, if the responder node 310 expects to receive an acknowledge packet 420 (shown in broken line) from the requester node 320 to indicate that the requester node 320 is busy and is unable to accept the response packet 410, the acknowledge packet 420 is expected to arrive approximately between t=T3 and t=T6, whereas the start (at t=T3) of the acknowledge packet 420 would be received before the end (at t=T4) of the responding time period 470. Thus, in this first case, the response phase 450 of the new request-response protocol of the present invention would resemble the response phase of the request-response protocol described above with respect to FIG. 2, whereas the responder node 310 attempts to re-transmit the response packet 410 at a later time. It should be understood that the acknowledge packet 420 (shown in broken line) could also represent an acknowledge packet (which indicates that the requester node 320 has accepted the response packet 410) that is eliminated in the new request-response protocol of the present invention but is utilized in the request-response protocol of the prior art.

However, in a second case, as illustrated in FIG. 4, the responder node 310 does not receive the start of the acknowledge packet 420 (which indicates that the requester node 320 is busy and is unable to accept the response packet 410) before the end (at t=T4) of the responding time period 470. Hence, the responder node 310 terminates the response phase 450 of the present data bus transaction to allow a request or a response phase 460 of the next data bus transaction to be performed on the 1394 data bus system 300. In other words, the responder node 310 quickly detects the absence of the acknowledge packet 420 (which indicates that the requester node 320 is busy and is unable to accept the response packet 410) and proceeds to terminate the response phase 450 of the present data bus transaction. Moreover, the present invention eliminates the acknowledge packet indicating that the requester node 320 has accepted the response packet 410 by relying on the fact that the requester node 320 can perform an error recovery procedure if the requester node 320 fails to receive the response packet 410 from the responder node 310. Since the responder node 310 knows that the requester node 320 does not have to arbitrate for the 1394 data bus system 300 because control of the 1394 data bus system 300 is automatically passed to the requester node 320 after receiving a response packet 410, the other nodes have to become aware (or the responder node 310 must provide to the other nodes an indication) that control of the 1394 data bus system 300 is being surrendered before t=T6 instead of after t=T6 like in the prior art. Since the length of the response phase 450 is shortened, the initiation of an arbitration procedure to perform a request or response phase 460 of a next data bus transaction is accelerated, leading to a higher data transfer rate. Here, the request or response packet 430 of a next data bus transaction is transmitted between t=T5 and t=T7, whereas the difference between t=5 and t=T6 represents an acceleration in the initiation of the request or response phase 460 of the next data bus transaction.

Moreover, the difference between the expected start (at t=T3) of the acknowledge packet 420 (which indicates that the requester node 320 is busy and is unable to accept the response packet 410) and the end (at t=T4) of the responding time period 470 can be made as small as desired, whereas a smaller difference leads to higher data transfer rates but increase the possibility of prematurely ending the response phase 450 before the responder node 310 receives the transmitted acknowledge packet 420 (which indicates that the requester node 320 is busy and is unable to accept the response packet 410).

In addition, the difference between the end (at t=T4) of the responding time period 470 and the start (at t=T5) of the request or response phase 460 of the next data bus transaction depends on the amount of time required to terminate the response phase 450 of the present data bus transaction and to communicate to other nodes in the 1394 data bus system 300 the fact that an arbitration procedure should be initiated because control of the 1394 data bus system 300 is being surrendered before t=T6 instead of after t=T6 like in the prior art.

Also, the difference between the start (at t=T5) of the request or response phase 460 of the next data bus transaction and the expected end (at t=T6) of the acknowledge packet 420 (which could indicate that the requester node 320 has accepted the response packet 410) represents the minimum amount of time by which the present invention has accelerated the initiation of the arbitration process to perform the request or response phase 460 of the next data bus transaction, leading to a higher data transfer rate than possible in the prior art.

Moreover, the fact that control of the 1394 data bus system 300 is being surrendered before t=T6 instead of after t=T6 like in the prior art does not interfere with the arbitration procedure. In particular, the responder node 310 is prevented from monopolizing control of the 1394 data bus system 300 upon the end (at t=T4) of the responding time period 470 because a fairness interval or a fair arbitration interval (which is specified in the 1394 Standard) is longer than the length of the responding time period 470, whereas the responder node 310 is able to participate in the arbitration process one time per fairness interval. In essence, at the end of the response phase 450, the other nodes are able to transmit data sooner than in the prior art while the responder node 310 can proceed to transmit data again after a time period controlled by the fairness interval.

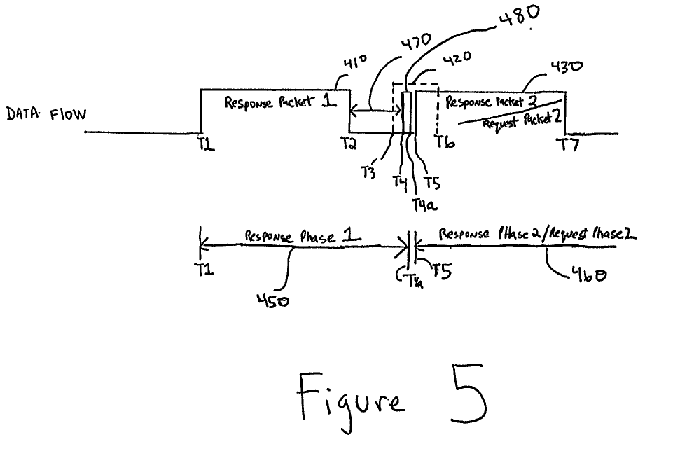

FIG. 5 illustrates a timing diagram showing a DATA FLOW which depicts a response phase of a data bus transaction utilizing the new request-response protocol according to a second embodiment of the present invention, whereas the DATA FLOW includes the data transfers performed by a responder node and a requester node. The discussion with respect to FIG. 4 is applicable to FIG. 5, except as described below. The corresponding labels of FIG. 4 have not been changed in FIG. 5.

In a second embodiment of the present invention, in the case (as illustrated in FIG. 5) where the responder node 310 does not receive the start of the acknowledge packet 420 (which indicates that the requester node 320 is busy and is unable to accept the response packet 410) before the end (at t=T4) of the responding time period 470, the responder node 310 transmits a control signal 480 to the 1394 data bus system to terminate the response phase 450 of the present data bus transaction to allow a request or a response phase 460 of the next data bus transaction to be performed on the 1394 data bus system 300, leading to a higher data transfer rate. Moreover, the present invention eliminates the acknowledge packet indicating that the requester node 320 has accepted the response packet 410 by relying on the fact that the requester node 320 can perform an error recovery procedure if the requester node 320 fails to receive the response packet 410 from the responder node 310. The control signal 480 informs the other nodes that control of the 1394 data bus system is being surrendered before t=T6 instead of after t=T6 like in the prior art, causing the acceleration of the initiation of an arbitration procedure to perform a request or response phase 460 of a next data bus transaction and leading to a higher data transfer rate. The control signal 480 is transmitted between t=T4 and t=T4a. The control signal 480 can be any type of signal.

Moreover, the response phase 450 ends when the control signal 480 has ended (at T=T4a). In addition, the difference between the end (at t=T4a) of the control signal 480 and the start (at t=T5) of the request or response phase 460 of the next data bus transaction depends on the amount of time required to terminate the response phase 450 of the present data bus transaction and to communicate to other nodes in the 1394 data bus system 300 the fact that an arbitration procedure should be initiated because control of the 1394 data bus system 300 is being surrendered before t=T6 instead of after t=T6 like in the prior art.

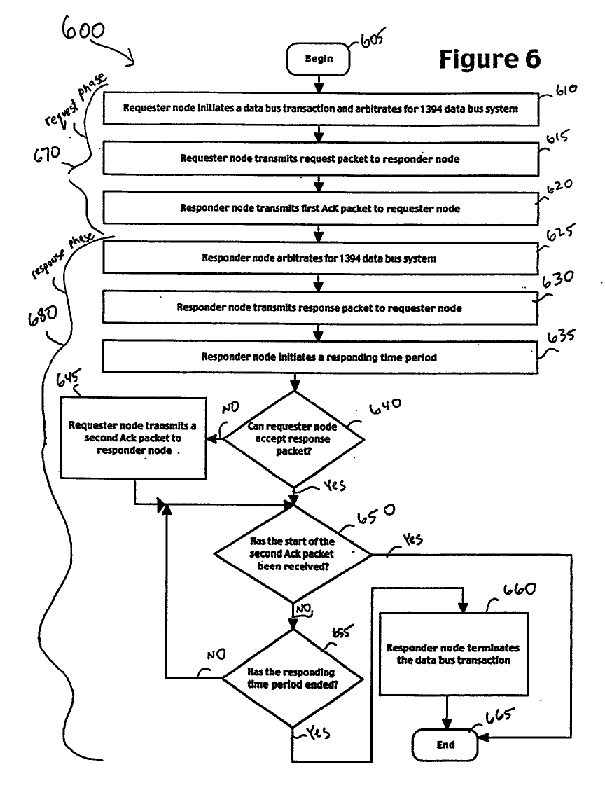

FIG. 6 illustrates a flow chart showing a method 600 of performing a data bus transaction in accordance with an embodiment of the present invention. In an embodiment, the method 600 is practiced in a 1394 data bus system having a plurality of nodes including a requester node and a responder node.

At step 605, the method 600 in accordance with an embodiment of the present invention begins.

As shown in step 610, the request phase 670 of the data bus transaction is commenced by a requester node initiating the data bus transaction and arbitrating for control of the 1394 data bus system.

Continuing with step 615, the requester node transmits a request packet to the responder node. At step 620, the responder node transmits a first acknowledge packet to the requester node, whereas the first acknowledge packet includes a code indicating a specific condition that occurred to the request packet (e.g., the request packet was accepted, the request packet was not accepted, an error was detected, etc.).

As shown in step 625, the response phase 680 of the data bus transaction is commenced by the responder node arbitrating for control of the 1394 data bus system.

Referring to step 630, the responder node transmits a response packet to the requester node. At step 635, the responder node initiates a responding time period. In an embodiment, the responding time period is a timeout period.

As shown in step 640, the requester node determines whether it can accept the response packet. If the requester node is unable to accept the response packet, the method 600 proceeds to step 645 where the requester node transmits a second acknowledge packet (which indicates that the requester node is busy and is unable to accept the response packet) to the responder node. Otherwise, the method 600 continues to step 650.

At step 650, the requester node determines whether the start of the second acknowledge packet (which indicates that the requester node is busy and is unable to accept the response packet) has been received. If the start of the second acknowledge packet has been received, the method 600 proceeds to step 665 where the response phase ends after the end of the second acknowledge packet, whereas the responder node attempts to re-transmit the response packet at a later time.

Otherwise, the method 600 proceeds to step 655. At step 655, the requester node determines whether the responding time period has ended. If the responding time period has not ended, the method 600 returns to step 650.

Otherwise, the method 600 proceeds to step 660. At step 660, the responder node terminates the current data bus transaction since the responding time period has expired.

In an embodiment, the responding time period is a timeout period. Thus, the responder node performs a timeout upon the end of the timeout period. Then, the responder node releases current control of the 1394 data bus system earlier than in the prior art to allow an arbitration among the plurality of nodes to establish or gain control of the 1394 data bus system to initiate a next data bus transaction, leading to a higher data transfer rate.

In an alternate embodiment, upon the end of the responsive time period, the responder node transmits a control signal to initiate an arbitration (earlier than in the prior art) among the plurality of nodes to establish or gain control of the 1394 data bus system to initiate a next data bus transaction, leading to a higher data transfer rate.

In yet another embodiment, each node in the 1394 data bus system is capable of detecting the fact that the start of the second acknowledge packet was not received by the responder node before the end of the responsive time period. Hence, the nodes initiate an arbitration (earlier than in the prior art) among the plurality of nodes to establish or gain control of the 1394 data bus system to initiate a next data bus transaction, leading to a higher data transfer rate.

At step 665, the method 600 ends.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of performing a data bus transaction between a first node and a second node in a data bus system having a plurality of nodes, said method comprising the steps of:
a) initiating said data bus transaction including a request packet generated by said first node and a response packet generated by said second node;
b) transmitting said request packet to said second node;
c) transmitting a first acknowledge packet to said first node;
d) transmitting said response packet to said first node;
e) initiating a start of a responsive time period;
f) if said first node is unable to accept said response packet, initiating transmission of a second acknowledge packet to said second node prior to an end of said responsive time period; and
g) if said second acknowledge packet of said step f) is not received, terminating said data bus transaction upon said end of said responsive time period, wherein said responsive time period is shorter than a time period between initiation of said start of said responsive time period and a terminal end of said second acknowledge packet.

2. A method as recited in claim 1 wherein said responsive time period is a timeout period of said second node.

3. A method as recited in claim 2 wherein said step g) includes the steps of:
performing a timeout upon said end of said timeout period, wherein said second node performs said timeout; and
releasing current control of said data bus system to allow an arbitration among said plurality of nodes to establish control of said data bus system to initiate a second data bus transaction.

4. A method as recited in claim 1 wherein said step g) includes the step of:
upon said end of said responsive time period, transmitting a signal to initiate an arbitration among said plurality of nodes to establish control of said data bus system to initiate a second data bus transaction.

5. A method as recited in claim 1 wherein said step g) includes the step of:
upon said end of said responsive time period, initiating an arbitration among said plurality of nodes to establish control of said data bus system to initiate a second data bus transaction, wherein each node is capable of detecting that said second node has not received said second acknowledge packet prior to said end of said responsive time period.

6. A method as recited in claim 1 wherein said second acknowledge packet indicates that said response packet was not accepted by said first node.

7. A method as recited in claim 1 wherein said data but system comprises a 1394 data bus system.

8. A method of performing a response phase of a data bus transaction between a first node and a second node in a data bus system having a plurality of nodes, said method comprising the steps of:
a) transmitting a response packet to said first node;
b) initiating a start of a responsive time period;
c) if said first node is unable to accept said response packet, initiating transmission of an acknowledge packet to said second node prior to an end of said responsive time period; and
d) if said acknowledge packet of said step c) is not received, terminating said data bus transaction upon said end of said responsive time period, wherein said responsive time period is shorter than a time period between said initiation of said start of said responsive time period and a terminal end of said acknowledge packet.

9. A method as recited in claim 8 wherein said responsive time period is a timeout period of said second node.

10. A method as recited in claim 9 wherein said step d) includes the steps of:
performing a timeout upon said end of said timeout period, wherein said second node performs said timeout; and
releasing current control of said data bus system to allow an arbitration among said plurality of nodes to establish control of said data bus system to initiate a second data bus transaction.

11. A method as recited in claim 8 wherein said step d) includes the step of:
upon said end of said responsive time period, transmitting a signal to initiate an arbitration among said plurality of nodes to establish control of said data bus system to initiate a second data bus transaction.

12. A method as recited in claim 8 wherein said step d) includes the step of:
upon said end of said responsive time period, initiating an arbitration among said plurality of nodes to establish control of said data bus system to initiate a second data bus transaction, wherein each node is capable of detecting that said second node has not received said acknowledge packet prior to said end of said responsive time period.

13. A method as recited in claim 8 wherein said acknowledge packet indicates that said response packet was not accepted by said first node.

14. A method as recited in claim 8 wherein said data bus system comprises a 1394 data bus system.

15. A data bus system comprising:
a plurality of nodes, wherein said plurality of nodes includes a first node and a second node, wherein said second node initiates a response phase of a data bus transaction by transmitting a response packet to said first node and initiates a start of a responsive time period,
wherein if said first node is unable to accept said response packet, said first node initiates transmission of an acknowledge packet to said second node prior to an end of said responsive time period,
wherein if said acknowledge packet is not received, said data bus transaction is terminated upon said end of said responsive time period, and
wherein said responsive time period is shorter than a time period between initiation of said start of said responsive time period and a terminal end of said acknowledge packet.

16. A data bus system as recited in claim 15 wherein said responsive time period is a timeout period of said second node.

17. A data bus system as recited in claim 16 wherein said second node performs a timeout upon said end of said timeout period, and then releases current control of said data bus system to allow an arbitration among said plurality of nodes to establish control of said data bus system to initiate a second data bus transaction.

18. A data bus system as recited in claim 15 wherein upon said end of said responsive time period, said second node transmits a signal to initiate an arbitration among said plurality of nodes to establish control of said data bus system to initiate a second data bus transaction.

19. A data bus system as recited in claim 15 wherein upon said end of said responsive time period, said plurality of nodes initiate an arbitration to establish control of said data bus system to initiate a second data bus transaction, and wherein each node is capable of detecting that said second node has not received said acknowledge packet prior to said end of said responsive time period.

20. A data bus system as recited in claim 15 wherein said acknowledge packet indicates that said response packet was not accepted by said first node.

21. A data bus system as recited in claim 15 wherein said data bus system comprises a 1394 data bus system.
